(19) United States
(12) Patent Application Publication
(10) Pub. No.: US 2018/0181550 A1
(43) Pub. Date: Jun. 28, 2018

(54) SCREEN INFORMATION GENERATION DEVICE AND SCREEN INFORMATION GENERATION METHOD

(71) Applicant: HITACHI, LTD., Tokyo (JP)

(72) Inventors: Genta KOREKI, Tokyo (JP); Jun MAEOKA, Tokyo (JP); Hideyuki KANUKA, Tokyo (JP); Hideki NAKAMURA, Tokyo (JP)

(73) Assignee: HITACHI, LTD., Tokyo (JP)

(21) Appl. No.: 15/491,368

(22) Filed: Apr. 19, 2017

(30) Foreign Application Priority Data
Dec. 27, 2016 (JP) 2016-254283

(51) Int. Cl. G06F 17/22

(52) U.S. Cl. CPC G06F 17/2288; G06F 17/2247; G06F 17/2211

(57) ABSTRACT

A screen information generation device analyzes, based on screen defining function information that is information about a function to define a screen, a source code to acquire screen definition information that is information related to definition of a screen described in the source code, and analyzes, based on screen transition function information that is information about a function to cause a screen to transition, the source code to thereby acquire screen transition-related information that is information about transition of a screen described in the source code, and generates, based on the screen definition information and the screen transition-related information, screen transition information including information indicative of a relationship between transition source screen information that is information about the screen of a transition source and transition destination screen information that is information about the screen of a transition destination.

### CROSS-REFERENCE TO RELATED APPLICATION

The present application claims priority pursuant to 35 U.S.C. § 119 from Japanese patent application no. 2016-254283, filed on Dec. 27, 2016, the entire disclosure of which is hereby incorporated herein by reference.

### BACKGROUND

### Technical Field

The present invention relates to a screen information generation device and a screen information generation method.

### Related Art

Japanese Patent Application Laid-Open Publication No. 2009-129038, hereinafter, referred to as the related document, describes that “there is provided a function that automatically checks the consistency of a developed application on the basis of a screen design document serving as a development source. A data item consistency extraction tool inputs the screen design document and a source code that defines an input item and screen transition, and converts the same into a document intermediate file XML and a source code intermediate file XML each being in an identical format, by executing the tool. After conversion, the data item consistency extraction tool compares two XMLs and outputs a difference therebetween, if any, to an item consistency extraction result file”.

### SUMMARY OF THE INVENTION

In developing and/or maintaining software, a deviation between a source code and a document (a system design document, a program specification, a screen specification document, or the like) often causes a problem. For example, in developing and/or maintaining a Web application, a specification change around a screen is frequently made. However, even when a source code has been added and/or the original source code has been modified, the corresponding modification of a document is often incomplete. It usually takes a great amount of efforts to eliminate the deviation caused in this manner.

In the related document, a difference between a source code and a screen design document is detected based on the source code that defines screen transition. However, the method of the related document assumes that there is a source code that defines screen transition, and thus cannot necessarily be applied to a case where the description about screen transition is distributed in various portions in the source code.

The present invention has been made in view of the above circumstances, and aims at providing a screen information generation device and a screen information generation method which support management of the documents used in developing and/or maintaining software.

According to an aspect of the present invention, there is provided a screen information generation device, including: an information storage unit configured to store a source code, screen defining function information that is information about a screen defining function to define a screen, and screen transition function information that is information about a screen transition function to cause a screen to transition; and a screen transition information generation unit including: a screen definition information acquisition unit configured to acquire screen definition information that is information about definition of a screen described in the source code, by analyzing the source code based on the screen defining function information; and a screen transition-related information acquisition unit configured to acquire screen transition-related information that is information about transition of a screen described in the source code, by analyzing the source code based on the screen transition function information, the screen transition information generation unit being configured to generate screen transition information including information indicative of a relationship between transition source screen information that is information about a screen of a transition source and transition destination screen information that is information about a screen of a transition destination, based on the screen definition information and the screen transition-related information.

Other than the above, the problem disclosed by the present application, and the method for solving the problem will be clarified through the detailed description of the invention and the accompanying drawings.

According to the present invention, it is possible to support management of the documents used in developing and maintaining software.

### BRIEF DESCRIPTION OF THE DRAWINGS

FIG. 1 illustrates the schematic configuration of an information processing system;

FIG. 2 illustrates the hardware configuration of an information processing device;

FIG. 3 illustrates the functions of a screen information generation device and the data stored in an information storage unit;

FIG. 4 is an example of a screen defining function table;

FIG. 5 is an example of a controller registration function table;

FIG. 6 is an example of a screen transition function table;

FIG. 7 is an example of a screen transition table;

FIG. 8 is an example of a transition handler usage confirmation table;

FIG. 9 is a flow chart showing screen transition information generation processing;

FIG. 10A is an example of the source code related to a screen definition, whereas FIG. 10B is an example of the source code related to registration of a controller;

FIG. 11 is an example of the source code related to the definition of a transition handler;

FIG. 12 is a flow chart showing a filtering process;

FIG. 13 is an example of the source code utilizing a transition handler;

FIG. 14 is a flow chart showing a complementing process; and

FIG. 15 is an example of a screen transition diagram.

### DETAILED DESCRIPTION OF THE INVENTION

Hereinafter, embodiments will be described in detail while referring to the accompanying drawings as necessary.

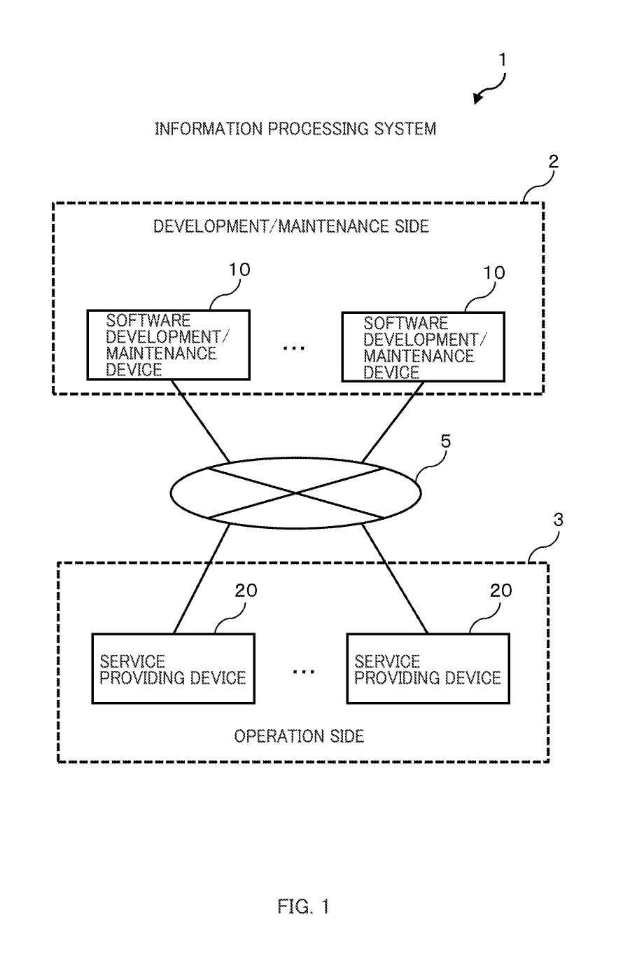

FIG. 1 illustrates the schematic configuration of an information processing system 1 described as an embodiment. As shown in FIG. 1, the information processing system 1 includes: one or more software development/maintenance devices 10 provided on a development/maintenance side 2 (system development center, etc.) where the development and/or maintenance of software are performed; and one or more service providing devices 20 provided on an operation side 3 (system center, data center, etc.) where software is operated. Both the software development/maintenance device 10 and the service providing device 20 are information processing devices (computers). The software development/maintenance device 10 and the service providing device 20 are communicatively connected via communication means 5 such as a LAN (Local Area Network) and/or the Internet.

The service providing device 20 is, for example, an information processing device (Web server, application server, etc.) that provides service to an information processing device (Web client etc.) on a user side by performing or providing software. The service providing device 20 may be virtually realized as in a case of, for example, a cloud server or the like provided by a cloud system. The service providing device 20 has a content data storing function that stores content data (character data, video data, still-image data, etc.), a content data delivering function that delivers content data in response to a request from a Web client, and the like, the functions to be realized by, for example, execution of software.

The software development/maintenance device 10 is an information processing device (computer) which is used in developing and/or maintaining the software executed by the service providing device 20. In the software development/maintenance device 10, software compliant with a predetermined framework supporting the development and/or maintenance of software executed by the service providing device 20 operates. Furthermore, the software development/maintenance device 10 manages, for example, the source code of the software executed by the service providing device 20 and documents (screen specification document, system design document, and program specification). In the present embodiment, for example, AngularJS (registered trademark) is assumed as the above-described framework, but the type of the framework is not necessarily limited thereto.

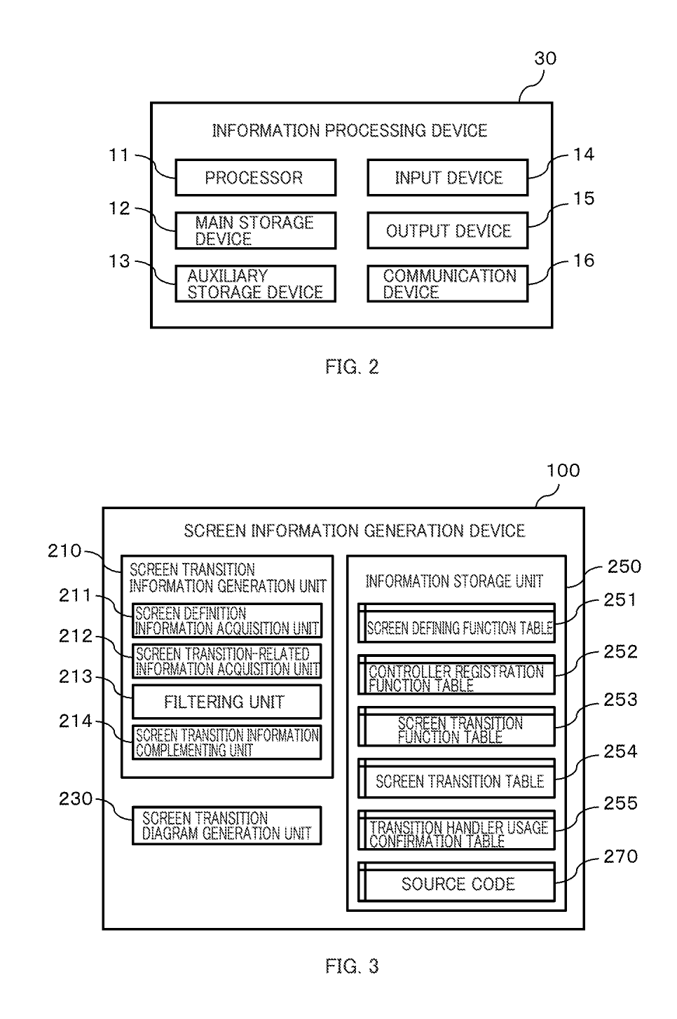

FIG. 2 shows an example (information processing device 30) of the hardware configuration used in realizing the software development/maintenance device 10 and/or service providing device 20. As shown in FIG. 2, the information processing device 30 includes a processor 11, a main storage device 12, an auxiliary storage device 13, an input device 14, an output device 15, and a communication device 16. These are communicatively connected to each other via communication means such as a non-illustrated bus.

The processor 11 is constituted by the use of, for example, a CPU (Central Processing Unit) or a MPU (Micro Processing Unit). The function of the software development/maintenance device 10 and the function of the service providing device 20 are realized by the processor 11 that reads and executes a program stored in the main storage device 12. The main storage device 12 is a device that stores a program and/or data, and is, for example, a ROM (Read Only Memory), a RAM (Random Access Memory), a nonvolatile semiconductor memory (NVRAM (Non Volatile RAM)), or the like.

The auxiliary storage device 13 is, for example, a reading/writing device of a recording medium such as a hard disk drive, a SSD (Solid State Drive), an optical storage device (CD (Compact Disc), a DVD (Digital Versatile Disc), etc.), a storage system, an IC card, an SD memory card, and an optical recording medium, or is a storage area of a cloud server, etc. The program and/or data stored in the auxiliary storage device 13 are loaded into the main storage device 12 as necessary. The auxiliary storage device 13 may be connected via communication means, like, for example, a network storage.

The input device 14 is a user interface that receives an external input, and is, for example, a keyboard, a mouse, a touch panel, or the like. The output device 15 is a user interface that provides various kinds of information such as processing progress and/or processed results, and is, for example, a screen display device (liquid crystal monitor, LCD (Liquid Crystal Display), a graphic card, etc.), a printer, or the like. Note that there may be adopted a configuration in which information is input/output to/from another device via, for example, the communication device 16, namely, a configuration in which the communication device 16 functions as the input device 14 and/or the output device 15.

The communication device 16 is a communication interface of wired system or wireless system which realizes the communication with another device which is performed via communication means such as a LAN and/or the Internet, and is, for example, an NIC (Network Interface Card), a wireless communication module, or the like.

FIG. 3 illustrates the functions of a screen information generation device 100 functioning as one type of the software development/maintenance device 10 and the data stored in the screen information generation device 100.

As shown in FIG. 3, the screen information generation device 100 includes each function (function unit or processing unit) of a screen transition information generation unit 210, a screen transition diagram generation unit 230, and an information storage unit 250. In addition, the screen transition information generation unit 210 includes a screen definition information acquisition unit 211, a screen transition-related information acquisition unit 212, a filtering unit 213, and a screen transition information complementing unit 214. These functions are realized by, for example, the processor 11 which reads and executes a program stored in the main storage device 12 or in the auxiliary storage device 13. Moreover, these functions are realized with, for example, the hardware (ASIC (Application Specific Integrated Circuit) etc.) of the screen information generation device 100. Note that the screen information generation device 100 may have the functions of, for example, an operating system, a device driver, a DBMS (DataBase Management System), or the like, other than the above-described functions.

As shown in FIG. 3, the information storage unit 250 stores each data of a screen defining function table 251 (screen defining function information), a controller registration function table 252, a screen transition function table 253 (screen transition function information), a screen transition table 254, a transition handler usage confirmation table 255, and a source code 270. The information storage unit 250 manages these data with, for example, a file system or a DBMS. Note that the screen information generation device 100 does not necessarily need to constantly store these data. Furthermore, the screen information generation device 100 may be configured to acquire the necessary data, as required, by communicating with another information processing device such as the service providing device 20.

The source code 270 is the data serving as the source of an execution code of the software that realizes the function of the service providing device 20. The source code 270 includes a descriptive sentence described in a predetermined language (HTML (Hyper Text Markup Language), script etc.). Note that, in the present embodiment, the source code 270 is assumed to be the one directed for AngularJS (registered trademark) or TypeScript (registered trademark), but the type of the source code 270 is not necessarily limited thereto.

The screen transition information generation unit 210 generates the screen transition table 254 including the information (hereinafter, referred to as screen transition information) indicative of a relationship between the information (transition source screen information) about the screen of a transition source (hereinafter, referred to as a transition source screen) and the information (transition destination screen information) about the screen of a transition destination (hereinafter, referred to as a transition destination screen). Note that the detail of the screen transition table 254 will be described later.

The screen definition information acquisition unit 211 acquires the information (hereinafter, referred to as screen definition information) about the definition of a screen from the source code 270, analyzes the acquired information, and reflects the result on the screen transition table 254.

The screen transition-related information acquisition unit 212 acquires the information (hereinafter, referred to as screen transition-related information) about the transition of a screen from the source code 270, analyzes the acquired information, and reflects the result on the screen transition table 254.

The filtering unit 213 performs filtering of the screen transition information (e.g., exclusion or removal of invalid contents). The detail of the processes performed by the filtering unit 213 will be described later.

The screen transition information complementing unit 214 performs complement of the screen transition information (e.g., addition or replenishment of information). The detail of the processing performed by the screen transition information complementing unit 214 will be described later.

The screen transition diagram generation unit 230 generates, based on the screen transition table 254, a screen transition diagram 1500 described later.

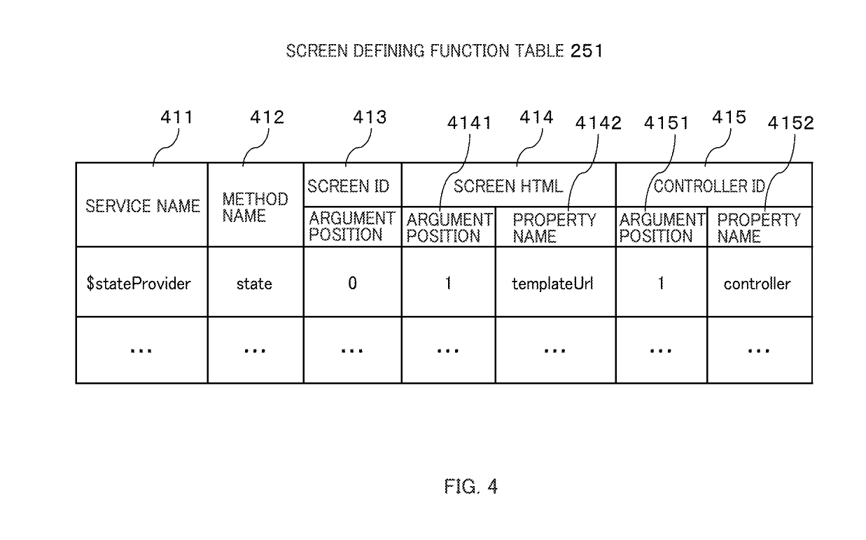

FIG. 4 shows an example of the screen defining function table 251 stored in the information storage unit 250. The screen defining function table 251 manages the information (hereinafter, referred to as screen defining function information) about the function to define a screen (hereinafter, referred to as a screen defining function) described in the source code 270.

As shown in FIG. 4, the screen defining function table 251 is constituted by one or more records each including each item of a service name 411, a method name 412, a screen ID (argument position) 413, a screen HTML 414 (argument position 4141 and property name 4142), and a controller ID 415 (argument position 4151 and property name 4152). Each row of the screen defining function table 251 corresponds to one screen defining function.

Among the above-described items, the service name (e.g., the name of a service provided by AngularJS (registered trademark)) of the screen defining function is set to the service name 411, whereas the method name of the screen defining function is set to the method name 412. In this example, “$stateProvider” is already set in the service name 411 and “state” is already set in the method name 412, respectively.

The information indicative of the argument position of the screen ID (identifier of a screen) in the relevant screen defining function is set in the screen ID (argument position) 413. In this example, “0” is already set in the screen ID (argument position) 413.

The information indicative of the argument position of an object including a screen descriptive sentence (HTML, in this example) in the relevant screen defining function is set in the screen HTML 414 (argument position 4141). In this example, “1” is already set in the screen HTML 414 (argument position 4141). Furthermore, the property name of the above-described object is set in the screen HTML 414 (property name 4142). In this example, “templateUrl” is already set in the screen HTML 414 (property name 4142).

The information indicative of the argument position of an object including the controller ID in the relevant screen defining function is set to the controller ID 415 (argument position 4151). In this example, “1” is already set in the controller ID 415 (argument position 4151). In addition, the property name of the controller ID of the above-described object is set to the controller ID 415 (property name 4152). In this example, “controller” is already set in the controller ID 415 (property name 4152).

Note that the controller is a controller in, for example, an MVC model (Model View Controller model). In the present embodiment, for ease of description, there is described, as an example, a case where one screen defined by the screen defining function is constituted by the use of one screen descriptive sentence and one controller, but the configuration of a screen defined by the screen defining function is not necessarily limited to the exemplified one.

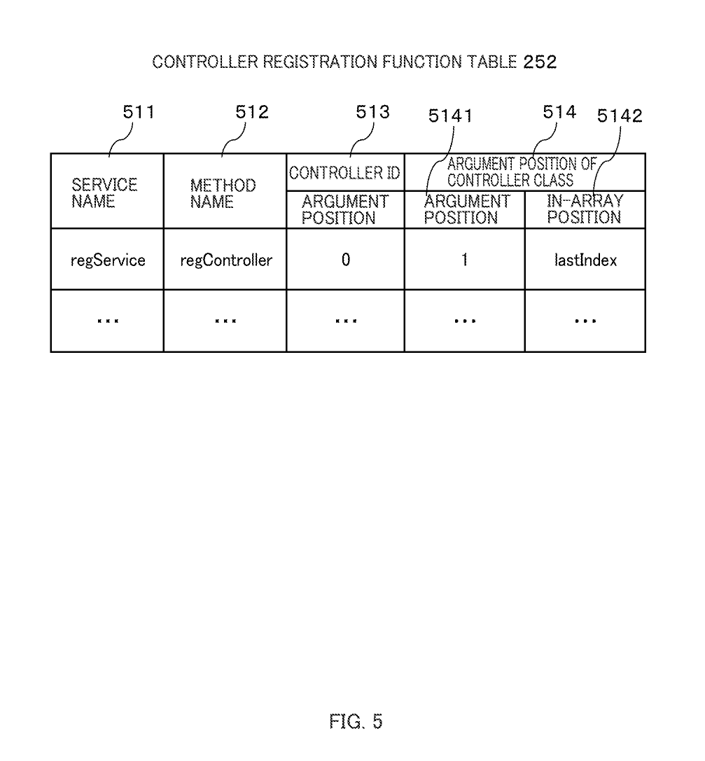

FIG. 5 shows an example of the controller registration function table 252 stored in the information storage unit 250. The controller registration function table 252 manages the information about a function to register a controller (hereinafter, referred to as a controller registration function).

As shown in FIG. 5, the controller registration function table 252 is constituted by one or more records each including each item of a service name 511, a method name 512, a controller ID (argument position) 513, and an argument position 514 (argument position 5141 and in-array position 5142) of a controller class name. Each row of the controller registration function table 252 corresponds to one controller registration function.

The service name of a controller registration function is set to the service name 511 and the method name of the controller registration function is set to the method name 512, respectively. In this example, “regService” is already set in the service name 511 and “regController” is already set in the method name 512, respectively.

Information indicative of the argument position of the controller ID in the relevant controller registration function is set to the controller ID (argument position) 513. In this example, “0” is already set in the controller ID (argument position) 513.

The information indicative of the argument position of an array including controller class name in the relevant controller registration function is set in the argument position 514 (argument position 5141) of the controller class name. In this example, “1” is already set in the argument position 514 (argument position 5141). In addition, the information indicative of the position in an array of controller class names of the array is set in the argument position 514 (in-array position 5142) of the controller class name. In this example, “lastIndex” is already set in the argument position 514 (in-array position 5142).

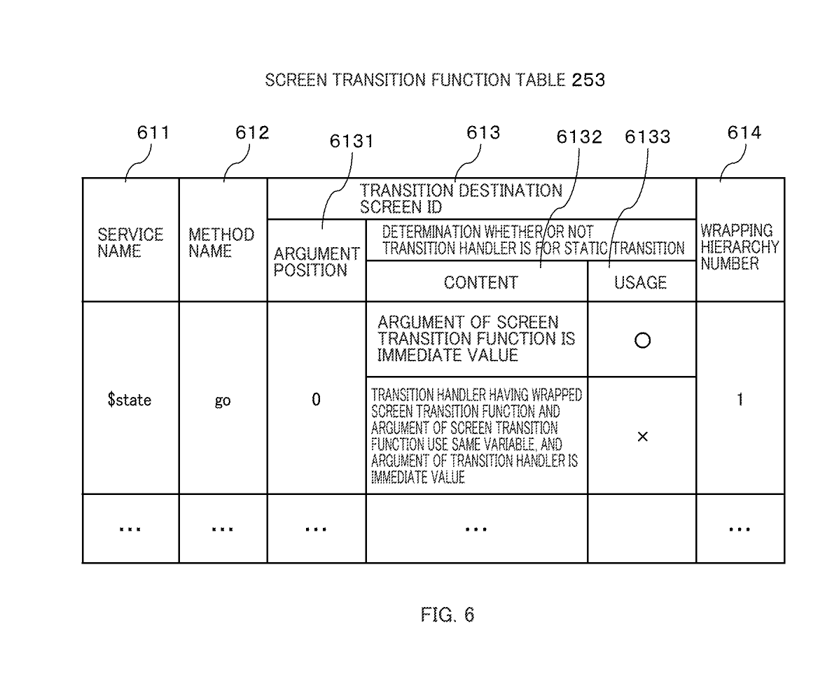

FIG. 6 shows an example of the screen transition function table 253 stored in the information storage unit 250. The screen transition function table 253 manages the information about the function to cause a screen to transition (hereinafter, referred to as a screen transition function).

As shown in FIG. 6, the screen transition function table 253 is constituted by one or more records each including each item of a service name 611, a method name 612, and a transition destination screen ID 613 (argument position 6131 and determinations (content 6132 and usage 6133) whether or not the transition handler is for performing static transition), and a wrapping hierarchy number 614. Each row of the screen transition function table 253 corresponds to one screen transition function.

The service name of a screen transition function is set to the service name 611, and the method name of the screen transition function is set to the method name 612. In this example, “$state” is already set in the service name 611 and “go” is already set in the method name 612, respectively.

The information indicative of the argument position of a screen ID (hereinafter, referred to as a transition destination screen ID) of the screen of a transition destination in the screen transition function is set in the transition destination screen ID 613 (argument position 6131). In this example, “0” is already set in the transition destination screen ID 613 (argument position 6131).

The information indicative of a method for determining whether or not a transition handler having wrapped a screen transition function is for performing static transition is set in the transition destination screen ID 613 (determination (content 6132) whether or not the transition handler is for performing static transition). The information indicating whether or not the above-described method is used (“YES” when the method is used, whereas “No” when the method is not used) is set in the transition destination screen ID 613 (determination (usage 6133) whether or not the transition handler is for performing static transition). In FIG. 6, there are exemplified, as the above method, the following two methods: a method for making determination based on whether or not a transition destination screen ID has been specified with an immediate value in the argument of the screen transition function; and a method for making determination based on whether the transition handler having wrapped a screen transition function and the argument of the screen transition function use the same variable and also use the argument of the transition handler as an immediate value.

Note that the static transition is transition in which the transition destination is determined in advance at the time of executing a program. In addition, in the following description, the transition which is not the static transition is also referred to also as dynamic transition. Namely, the dynamic transition is transition in which the transition destination is not determined in advance, but is determined at the time of executing a program.

The information indicating whether or not a function having wrapped a transition function with one hierarchy is used as the transition handler is set to the wrapping hierarchy number 614. In this example, “1” is already set in the wrapping hierarchy number 614.

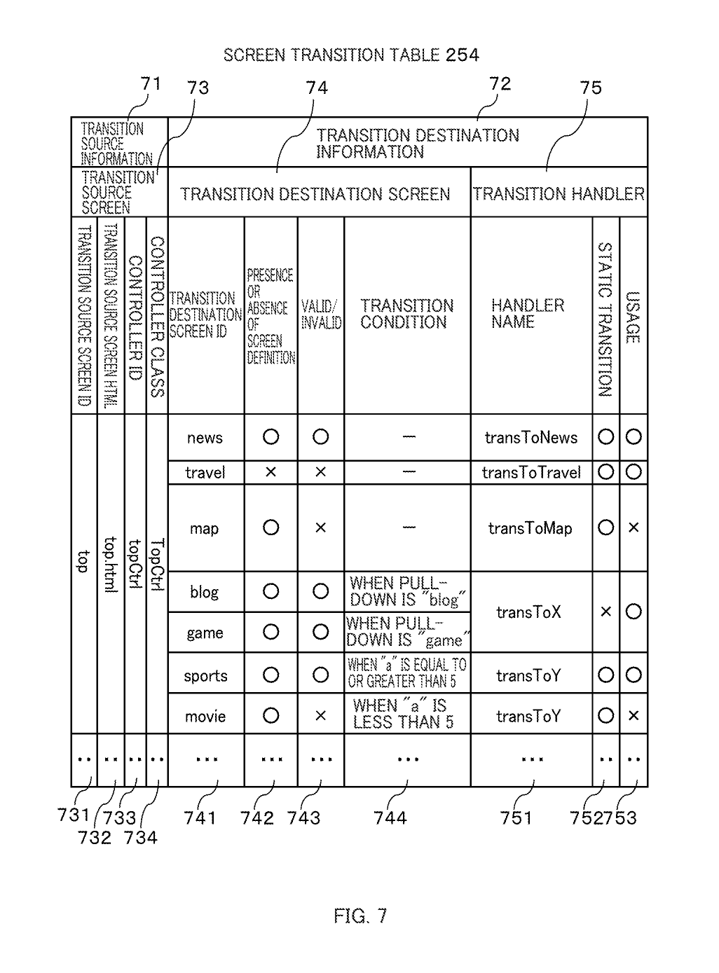

FIG. 7 is an example of the screen transition table 254 stored in the information storage unit 250. The screen transition table 254 manages the information indicative of a relationship between the information about a transition source screen and the information about a transition destination screen. Note that the screen transition table 254 is constituted in units of a transition source screen. In addition, in this example, the screen transition table 254 is assumed to manage the information about a full range of transition source screens to be analyzed by the screen information generation device 100.

As shown in FIG. 7, the screen transition table 254 is constituted by one or more records each including each item of transition source information 71 and transition destination information 72. As shown in FIG. 7, the transition source information 71 includes a transition source screen 73 as an item. Furthermore, the transition destination information 72 includes each item of a transition destination screen 74 and a transition handler 75.

The transition source screen 73 includes each item of a transition source screen ID 731, a transition source screen HTML 732, a controller ID 733, and a controller class 734.

Among them, the screen ID of a transition source screen is set in the transition source screen ID 731. In this example, “top” is already set in the transition source screen ID 731.

The information (the file name of a screen descriptive sentence, etc.) that specifies the source code (screen descriptive sentence) of a transition source screen is set in the transition source screen HTML 732. In this example, “top.html” is already set in the transition source screen HTML 732.

An identifier (hereinafter, referred to as a controller ID) of the controller of the relevant transition source screen is set to the controller ID 733. In this example, “topCtrl” is already set to the controller ID 733.

The class name of a controller specified by the controller ID 733 is set to the controller class 734. In this example, “TopCtrl” is already set in the controller class 734.

As shown in FIG. 7, the transition destination screen 74 includes each item of a transition destination screen ID 741, presence or absence of screen definition 742, valid/invalid 743, and a transition condition 744.

Among them, the screen ID of a transition destination screen is set in the transition destination screen ID 741. In this example, “news”, “travel”, “map”, “blog”, “game”, “sports”, and “movie” are already set as the screen ID in the transition destination screen ID 741.

Information indicating whether or not there is any definition of a screen (“YES” indicating that there is any definition of a screen (indicating the presence thereof) or “NO” indicating there is no definition of a screen) is set to the presence or absence of screen definition 742.

The information indicating that the relevant transition destination screen is valid/invalid (“YES” indicative of valid or “NO” indicative of invalid) is set to the valid/invalid 743. In this example, when “YES” is already set in the presence or absence of screen definition 742 and also “YES” is already set in the usage 753, “YES” is set to the valid/invalid 743 and otherwise “NO” is set to the valid/invalid 743.

When the transition handler is for performing dynamic transition and also for performing the transition to a plurality of screens, the information indicative of a condition under which a screen is caused to transition (hereinafter, referred to as a transition condition) is set to the transition condition 744.

As shown in FIG. 7, the transition handler 75 includes each item of a handler name 751, static transition 752, and usage 753.

The name of a transition handler (hereinafter, referred to as the handler name) defined in the relevant transition source screen is set to the handler name 751.

The information (“YES” if the transition handler is for performing static transition, whereas “NO” if the transition handler is for performing dynamic transition) indicating whether the transition handler is for performing static transition or for performing dynamic transition is set to the static transition 752.

The information indicating whether or not the transition handler is actually in use (“YES” if the transition handler is in use, whereas “NO” if the transition handler is not in use) is set to the usage 753.

In this example, the transition handler with the handler name 751 of “transToNews” is a handler that performs the static transition to a screen of “news”, and “YES” is already set in the presence or absence of screen definition 742 and “YES” is already set in the usage 753, respectively. As the result, “YES” is already set in the valid/invalid 743. Note that, since the “transToNews” is a handler which causes the transition only to the “news” screen, the transition condition 744 is not set.

Furthermore, the transition handler with the handler name 751 of “transToTravel” is a handler that performs the static transition to a screen “travel”, but since “NO” is already set in the presence or absence of screen definition 742, “NO” is already set in the valid/invalid 743. In addition, since the “transToTravel” is a handler which causes the transition only to the “travel” screen, the transition condition 744 is not set.

Moreover, the transition handler with the handler name 751 of “transToMap” is a handler that performs the static transition to a screen “map”, but since “NO” is already set in the usage 753, “NO” is already set in the valid/invalid 743.

The transition handler with the handler name 751 of “transToX” is a handler that performs the dynamic transition to a screen “blog” or “game”, and the transition to any of the screen “blog” or “game” is also valid. In this example, since, for either screen, “YES” is already set in the presence or absence of screen definition 742 and also “YES” is already set in the usage 753, “YES” is already set in the valid/invalid 743 for either screen. Note that this transition handler is for performing dynamic transition and thus transition to either screen of “blog” or “game” is determined at the time of executing software. As shown in FIG. 7, a content meaning the case where “blog” is specified with a pull-down menu displayed on a screen HTML as the transition condition 744 is already set in “blog” and a content meaning the case where “game” is specified with a pull-down menu displayed on the screen HTML as the transition condition 744 is already set in “game”, respectively.

The transition handler with the handler name 751 of “transToY” is a handler that performs the static transition to the screens “sports” and “movie.” As to this transition handler, “YES” is already set in the usage 753 for “sports”, whereas “NO” is already set in the usage 753 for “movie”. Accordingly, “YES” is already set in the valid/invalid 743 for “sports”, whereas “NO” is already set in the valid/invalid 743 for “movie.” As shown in FIG. 7, a content meaning the case where “sports” is specified with a pull-down menu displayed on a screen HTML as the transition condition 744 is already set in “sports” and a content meaning the case where “movie” is specified with a pull-down menu displayed on the screen HTML as the transition condition 744 is already set in “movie”, respectively.

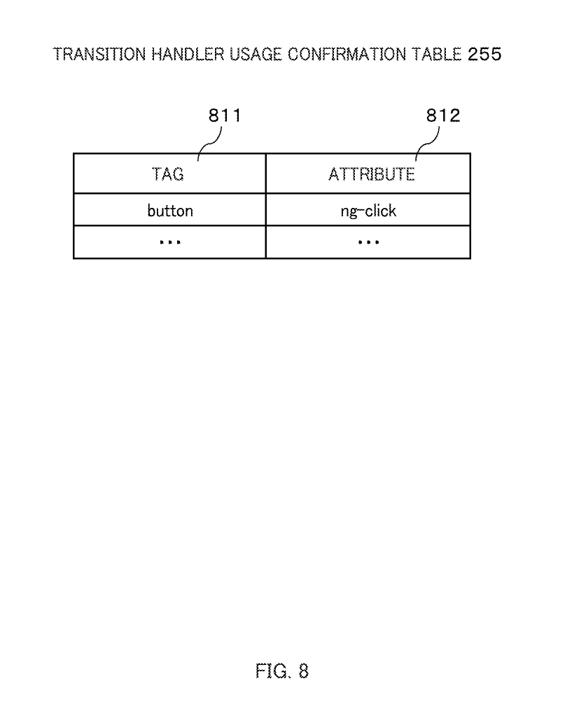

FIG. 8 shows an example of the transition handler usage confirmation table 255. The transition handler usage confirmation table 255 manages the information used in determining whether or not a transition handler is actually in use. In this example, the transition handler usage confirmation table 255 manages the information (hereinafter, referred to as transition handler utilization confirmation information) indicating which portion in the screen descriptive sentence (HTML sentence) is associated with a transition handler, and manages the information indicative of a correspondence between a tag 811 “button” and an attribute 812 “ng-click”.

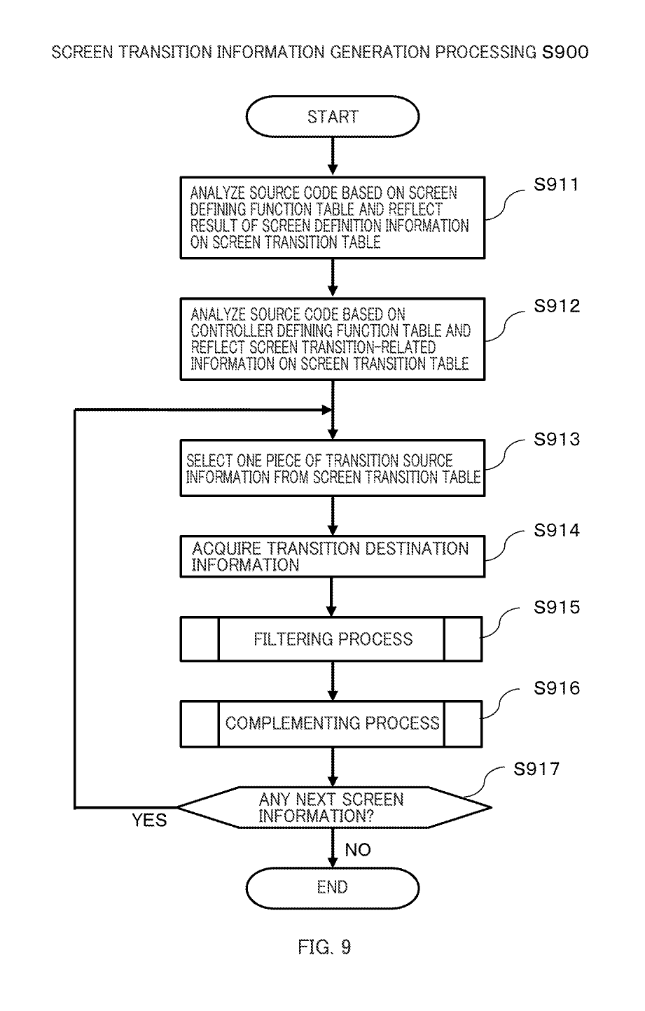

FIG. 9 is a flow chart describing the processing (hereinafter, referred to as a screen transition information generation processing S900) which is performed when the screen information generation device 100 generates the screen transition table 254. Hereinafter, the screen transition information generation processing S900 will be described with reference to this diagram. Note that the screen transition information generation processing S900 is started by a user who has performed a predetermined startup processing on, for example, the screen information generation device 100.

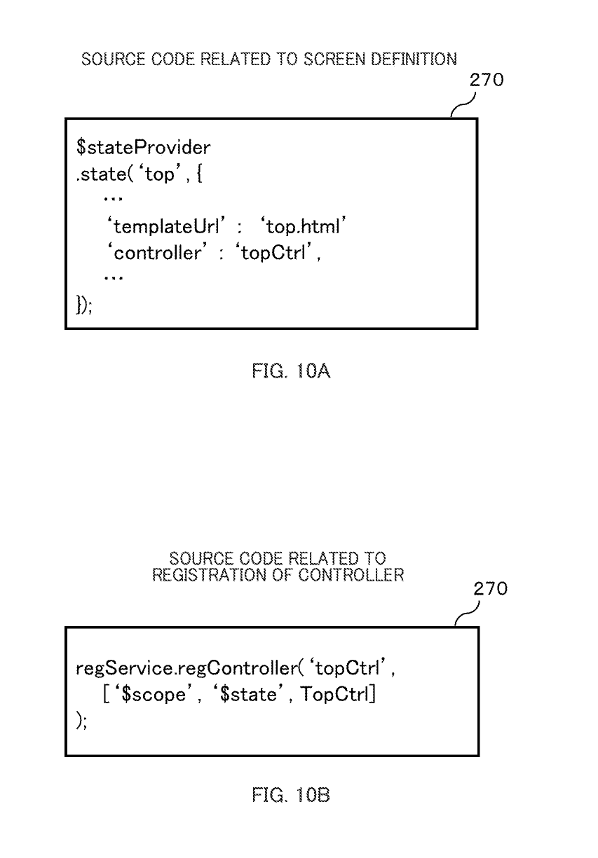

As shown in FIG. 9, first the screen definition information acquisition unit 211 analyzes the source code 270 with reference to the screen defining function table 251, and reflects the results (transition source screen ID 731 and transition source screen HTML 732) on the screen transition table 254 (S911). Furthermore, the screen definition information acquisition unit 211 analyzes the source code 270 with reference to the controller registration function table 252, and reflects the results (controller ID 733 and controller class 734) on the screen transition table 254 (S912). These processes (S911 and S912) will be specifically described, with the source code 270 shown in FIGS. 10A and 10B, the screen defining function table 251 shown in FIG. 4, and the controller registration function table 252 shown in FIG. 5 being taken as an example.

First, based on the information of “0” set in the screen ID (argument position) 413 of the screen defining function table 251 shown in FIG. 4, the screen definition information acquisition unit 211 acquires “top” set at the 0th argument position as the transition source screen ID 731, from the source code 270 of the screen definition shown in FIG. 10A.

Next, based on “1” set in the screen HTML 414 (argument position 4141) of the screen defining function table 251 shown in FIG. 4 and on “templateUrl” set in the screen HTML 414 (property name 4142), the screen definition information acquisition unit 211 acquires, as the transition source screen HTML 732, “top.html” set at the first argument position of an object with the property name “templateUrl” from the source code 270 of the screen definition shown in FIG. 10A.

Subsequently, based on “1” set in the controller ID 415 (argument position 4151) and “controller” set in the controller ID 415 (property name 4152) of the screen defining function table 251 shown in FIG. 4, the screen definition information acquisition unit 211 acquires, as the controller ID 733, “topCtrl” set at the first argument position of an object with the property name “controller” from the source code 270 shown in FIG. 10A.

Then, from “topCtrl” acquired as the controller ID 733 and from the information of “0” set in the controller ID (argument position) 513 of the controller registration function table 252, the screen definition information acquisition unit 211 specifies the source code 270 related to the registration of a controller shown in FIG. 10B. In addition, based on the information (argument position 5141 and in-array position 5142) set in the argument position 514 of the controller class, the screen definition information acquisition unit 211 acquires, as the controller class 734, a character string “TopCtrl” at the last indexing position of an array at the first argument position from the source code 270 shown in FIG. 10B.

The screen definition information acquisition unit 211 reflects, as the transition source information 71 (transition source screen 73), the thus acquired information (transition source screen ID 731, transition source screen HTML 732, controller ID 733, and controller class 734) on the screen transition table 254.

Returning to FIG. 9, next, the screen transition-related information acquisition unit 212 selects one of the transition source information 71 listed in the screen transition table 254 (one of the records distinguished by the transition source screen ID 731) (S913).

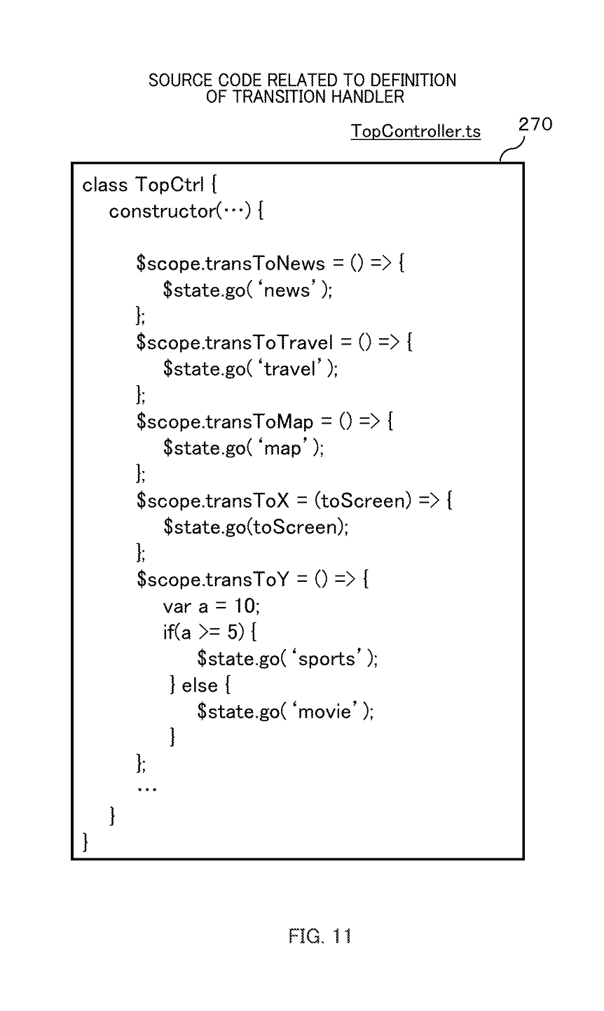

Subsequently, the screen transition-related information acquisition unit 212 analyzes the controller class specified from the controller class 734 of the transition source information 71 being selected, acquires the transition destination screen ID 741, the handler name 751, and the content of the static transition 752, and reflects, as the transition destination information 72, the acquired contents on the screen transition table 254. The process of S914 will be specifically described, with the screen transition table 254 shown in FIG. 7, the source code 270 related to the definition of the transition handler of FIG. 11, and the screen transition function table 253 of FIG. 6 being taken as an example.

First, the screen transition-related information acquisition unit 212 acquires, as a transition handler, a function that has wrapped a screen transition function described in the screen transition function table 253 of FIG. 6 of the controller class set in the controller class 734, with hierarchy set in the wrapping hierarchy number 614 of the relevant screen transition function table 253. In addition, the screen transition-related information acquisition unit 212 analyzes the 0th argument (acquired from “0” set at the argument position 6131 of FIG. 6) of the screen transition function, and determines, if the argument is an immediate value, that the transition handler is a handler that performs static transition. In a case of the source code 270 of FIG. 11, the screen transition-related information acquisition unit 212 acquires “transToNews”, “transToTravel”, “transToMap”, “transToX”, and “transToY” as the transition handler.

Furthermore, the screen transition-related information acquisition unit 212 analyzes the use position of a function (in this example, the function with the service name 611 of “$state” and the method name 612 of “go”) described in the screen transition function table 253 which a transition handler utilizes thereinside, thereby determining whether or not the transition handler is for performing static transition, and acquires the screen of a transition destination (transition destination screen ID 741) from the transition handler. For example, when the transition handler utilizes, as an immediate value, the 0th argument of a function (in this example, the function with the service name 611 of “$state” and the method name 612 of “go”) described in the screen transition function table 253, the screen transition-related information acquisition unit 212 determines that the transition handler performs static transition. Moreover, when the 0th argument is in use by a method other than the method for specifying the 0th argument as an immediate value, the screen transition-related information acquisition unit 212 determines that the transition handler performs dynamic transition. In a case of the source code 270 of FIG. 11, the screen transition-related information acquisition unit 212 determines that the handlers with “transToNews”, “transToTravel”, “transToMap”, and “transToY” are handlers that perform static transition and the handler with “transToX” is a handler that performs dynamic transition. As to the transition handler determined as the handler that performs static transition, the screen transition-related information acquisition unit 212 sets “YES” to the corresponding static transition 752 of the screen transition table 254. Moreover, as to the transition handler determined as the handler that performs dynamic transition, the screen transition-related information acquisition unit 212 sets “NO” to the corresponding static transition 752 of the screen transition table 254.

When the transition handler is for performing static transition, the screen transition-related information acquisition unit 212 acquires, as the transition destination screen ID 741, the 0th argument of a function (in this example, the function with the service name 611 of “$state” and the method name 612 of “go”) described in the screen transition function table 253 which a transition handler utilizes thereinside. In a case of the source code 270 shown in FIG. 11, the transition destination screen ID 741 of “transToNews” is “news”, the transition destination screen ID 741 of “transToTravel” is “travel”, the transition destination screen ID 741 of “transToMap” is “map”, and the transition destination screen ID 741 of “transToY” is “sports” or “movie.” Note that, since the handler with “transToX” is a handler that performs dynamic transition, the actual transition destination is determined at the time of executing a program. As described later, the screen transition-related information acquisition unit 212 causes, for example, a user to input the contents (in this example, “blog” and “game”) of the transition destination screen ID 741. Note that it is assumed that the contents of the transition destination screen ID 741 of “transToX” have not been set at the time point of process S914. A specific method for setting the transition destination screen ID 741 will be described later.

As described above, the screen transition-related information acquisition unit 212 analyzes the controller class specified by the screen definition information acquisition unit 211 and specifies a transition handler that efficiently performs transition of a screen. Furthermore, the screen transition-related information acquisition unit 212 determines whether the transition handler is a handler that performs static transition or a handler that performs dynamic transition, and appropriately sets the contents of the transition destination information 72 on the screen transition table 254.

Returning to FIG. 9, next, the filtering unit 213 performs filtering of the transition destination information 72 acquired in S914 (S915). Note that the detail of this process (hereinafter, referred to as a filtering process S915) will be described later.

Subsequently, the screen transition information complementing unit 214 complements the screen transition information acquired in S914 (S916). Note that the detail of this process (hereinafter, referred to as a complementing process S916) will be described later.

Then, the screen transition-related information acquisition unit 212 determines whether or not there is any unselected one among the transition source information 71 described in the screen transition table 254. When the screen transition-related information acquisition unit 212 determines that there is any unselected transition source information 71 (S917: YES), the processing returns to S913, and the screen transition-related information acquisition unit 212 repeats the processing (S914 and subsequent processes) similar to the above, with respect to the unselected transition source information 71. When the screen transition-related information acquisition unit 212 determines that there is not any unselected transition source information 71 (S917: NO), the screen transition information generation processing S900 is completed.

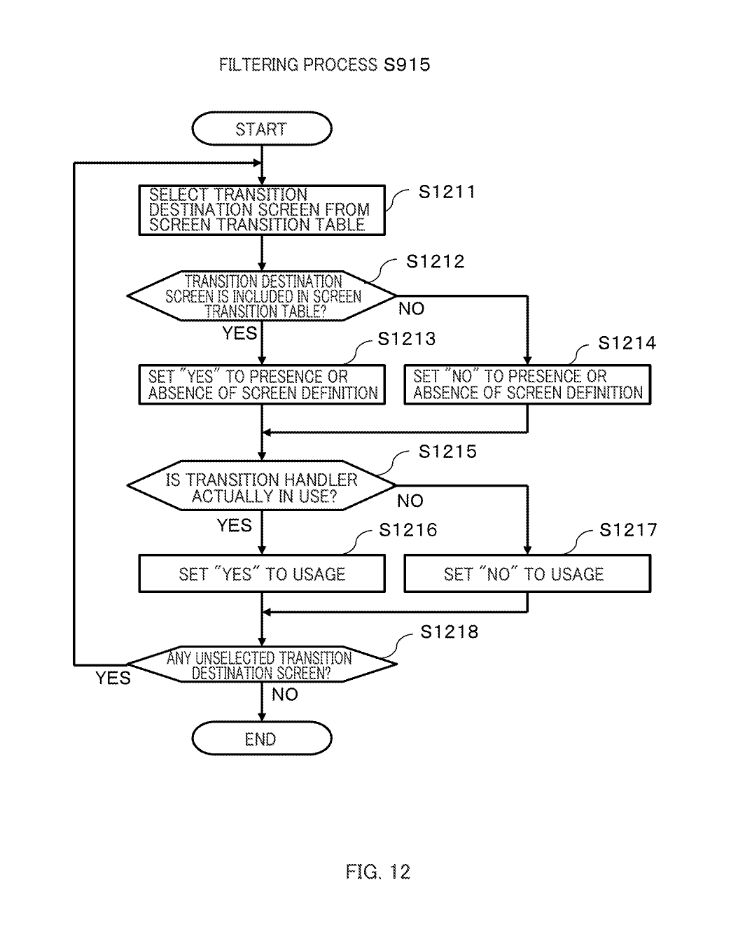

FIG. 12 is a flow chart describing the detail of the filtering process S915 of FIG. 9. Hereinafter, the filtering process S915 will be described with reference to FIG. 12.

First, the filtering unit 213 selects, from the screen transition table 254, one of the transition destination screens 74 (one of the transition destination screens distinguished by the transition destination screen ID 741 of a record distinguished by the transition source screen ID 731) (S1211).

Subsequently, the filtering unit 213 determines whether or not a transition destination screen being selected is included as the transition source screen 73 in the screen transition table 254 (whether or not there is the transition destination screen 74 being selected in the screen transition table 254) (S1212). When the filtering unit 213 determines the transition destination screen being selected is included as the transition source screen 73 in the screen transition table 254 (S1212: YES), the processing proceeds to S1213. On the other hand, when the filtering unit 213 determines the transition destination screen being selected is not included as the transition source screen 73 in the screen transition table 254 (S1212: NO), the processing proceeds to S1214.

In S1213, the filtering unit 213 sets “YES” to the presence or absence of screen definition 742 of the screen transition table 254 of the transition destination screen being selected (S1213). Subsequently, the processing proceeds to S1215. In addition, in S1214, the filtering unit 213 sets “NO” to the presence or absence of screen definition 742 of the screen transition table 254 of the transition destination screen being selected (S1214). Then, the processing proceeds to S1215.

In S1215, the filtering unit 213 determines whether or not the transition handler 75 of the transition destination screen being selected is actually in use. When the filtering unit 213 determines that the transition handler 75 of the transition destination screen being selected is actually in use (S1215: YES), the processing proceeds to S1216. When the filtering unit 213 determines that the transition handler 75 of the transition destination screen being selected is not actually in use (S1215: NO), the processing proceeds to S1217.

Here, the filtering unit 213 determines whether or not the transition handler 75 is actually in use, by analyzing the source code 270 specified in the transition source screen HTML 732 of the transition destination screen being selected. Specifically, when a combination of the tag 811 and attribute 812 of the transition handler usage confirmation table 255 is described in the source code 270 and the transition handler 75 is used as the attribute 812, the filtering unit 213 determines that the relevant transition handler 75 is actually in use. Note that, when a transition handler is used at a plurality of places in one or more screen descriptive sentences regarding an identical screen, the filtering unit 213 regards the identical transition handler used in transition to an identical transition destination screen as the same and does not output the duplicated screen transition information. Accordingly, there can be prevented the inclusion of the redundant information as the screen transition information.

In S1216, the filtering unit 213 sets “YES” to the usage 753 of the screen transition table 254. Subsequently, the processing proceeds to S1218. In S1217, the filtering unit 213 sets “NO” to the usage 753 of the screen transition table 254. Then, the processing proceeds to S1218.

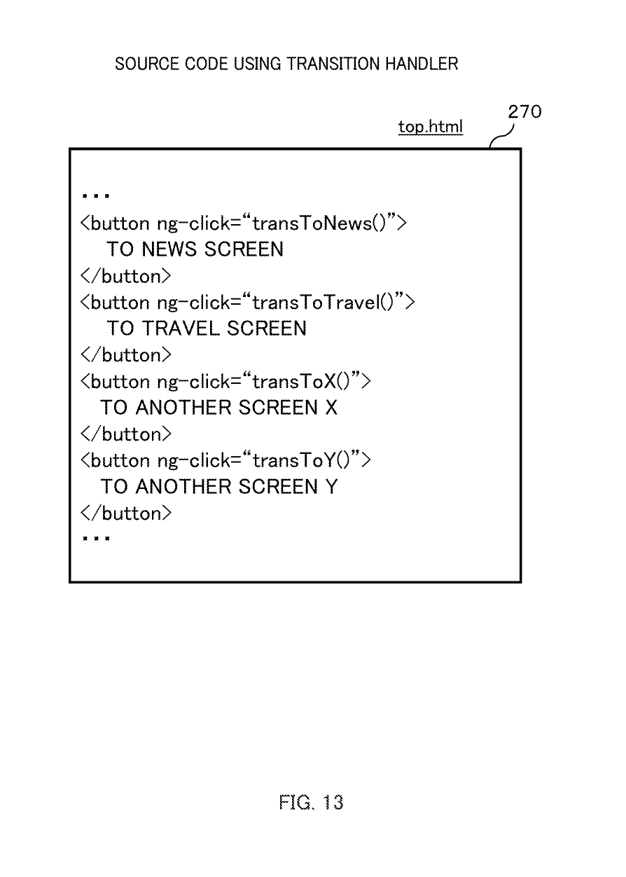

Here, for example, in the example of the source code 270 shown in FIG. 13, four transition handlers with the name of “transToNews”, “transToTravel”, “transToX”, and “transToY” are in use by the combination of the “button” tag and the “ng-click” attribute. However, since “transToY” might transition to two screens with the names of “sports” and “movie” as shown in FIG. 7, the filtering unit 213 determines whether or not the transition handler is in use in each case. For example, in the example of the source code 270 of FIG. 11, since a variable “a” is already set to “10” as “var a=10”, the transition with the screen transition destination of “movie” cannot practically occur, and the filtering unit 213 determines that the transition handler “transToY” is actually using “movie”, and sets “YES” to the usage 753. Furthermore, the filtering unit 213 determines that the transition handler “transToY” is not actually using “sports”, and sets “NO” to the usage 753.

Returning to FIG. 12, in S1218 the filtering unit 213 determines whether or not there is any unselected one among the transition destination screens 74 described in the screen transition table 254. When the filtering unit 213 determines that there is any unselected one (S1218: YES), the processing returns to S1211, and the filtering unit 213 repeats, with respect to the unselected transition destination screen 74, the processing (S1212 and subsequent processes) similar to the above. When the filtering unit 213 determines that there is not any unselected one (S1218: NO), the filtering process S915 is completed, and the processing proceeds to the complementing process S916 of FIG. 9.

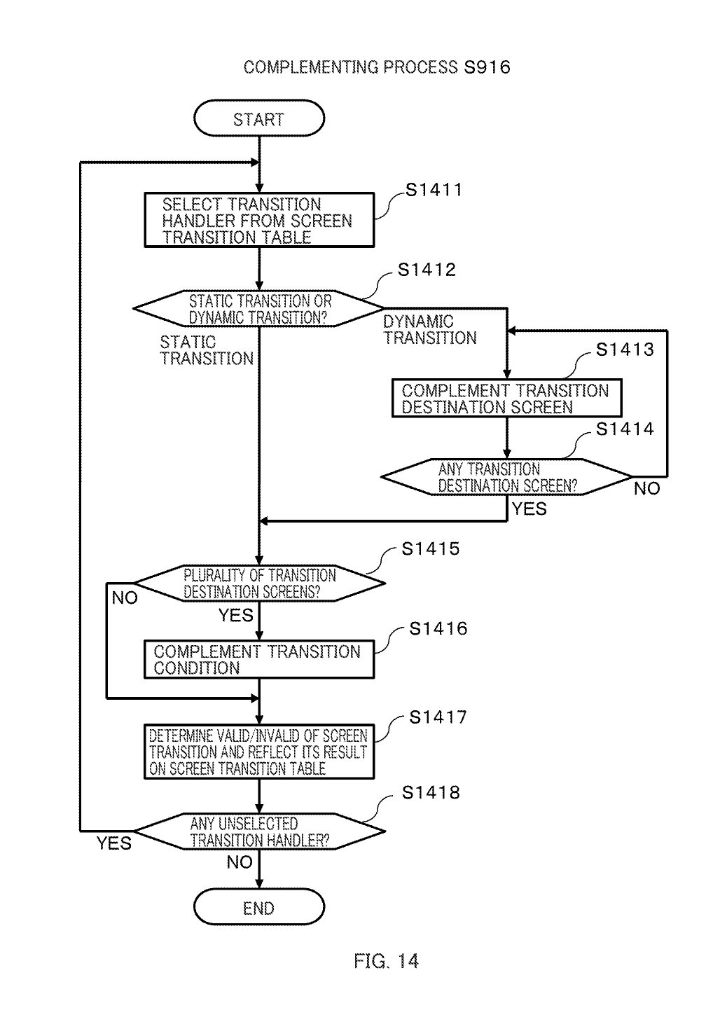

FIG. 14 is the flow chart describing the complementing process S916 of FIG. 9. Hereinafter, the complementing process S916 will be described with reference to FIG. 14.

First, the screen transition information complementing unit 214 selects one transition handler 75 (one of the transition handlers distinguished by the handler name 751 of a record distinguished by the transition source screen ID 731) from the screen transition table 254 (S1411).

Next, the screen transition information complementing unit 214 determines, with reference to the screen transition table 254, whether or not a transition handler being selected is for performing static transition (S1412). When the screen transition information complementing unit 214 determines that the transition handler being selected is for performing static transition (S1412: static transition), the processing proceeds to S1415. On the other hand, when the screen transition information complementing unit 214 determines that the transition handler being selected is not for performing static transition (is for performing dynamic transition) (S1412: dynamic transition), the processing proceeds to S1413.

In S1413, the screen transition information complementing unit 214 complements the transition destination screen ID 741 serving as a candidate for the transition destination screen of dynamic transition of the screen transition table 254. This complement will be performed by, for example, a method for accepting an input of the screen ID from a user via a pop-up screen or the like, or by a method for describing the screen ID serving as a candidate as a comment or the like inside the source code 270 in advance and for utilizing the same for complement.

In S1414, the screen transition information complementing unit 214 determines whether or not the transition destination screen ID 741 complemented in S1413 is included in the transition source screen ID 731 of the screen transition table 254 (whether or not there is actually any complemented transition destination screen). When the screen transition information complementing unit 214 determines that the complemented transition destination screen ID 741 is included in the transition source screen ID 731 of the screen transition table 254 (S1414: YES), the processing proceeds to S1415. When the screen transition information complementing unit 214 determines that any complemented transition destination screen ID 741 is not included in the transition source screen ID 731 of the screen transition table 254 (S1414: NO), the processing returns to S1413.

In S1415, the screen transition information complementing unit 214 determines, based on the screen transition table 254, whether or not there is a plurality of transition destination screens of the transition handler being selected. When the screen transition information complementing unit 214 determines that there is a plurality of transition destination screens of the transition handler (S1415: YES), the processing proceeds to S1416. On the other hand, when the screen transition information complementing unit 214 determines that there is not a plurality of transition destination screens of the transition handler (S1415: NO), the processing proceeds to S1417.

In S1416, the screen transition information complementing unit 214 complements the transition condition for each transition destination screen of the transition handler being selected. This complement will be performed, for example, with a method of accepting an input of a transition condition from a user via a pop-up screen or the like, or a method for describing a transition condition as a comment or the like inside the source code 270 in advance and for using the same for complement.

In S1417, the screen transition information complementing unit 214 determines, with respect to the transition handler being selected, whether or not the transition in the screen transition table 254 is valid or invalid, and reflects the determination result on the valid/invalid 743. As described above, in this example, when “YES” is already set in the presence or absence of screen definition 742 and “YES” is already set in the column of the usage 753, the screen transition information complementing unit 214 sets “YES” to the valid/invalid 743 otherwise sets “NO” to the column of usage 753.

In S1418, the screen transition information complementing unit 214 determines whether or not there is any unselected transition handler. When the screen transition information complementing unit 214 determines that there is any unselected transition handler (S1418: YES), the processing returns to S1411, and the screen transition information complementing unit 214 repeats, with respect to the unselected transition handler 75, the processing (S1412 and subsequent processes) similar to the above. When the screen transition information complementing unit 214 determines with there is not any unselected transition handler (S1418: NO), the complementing process S916 is completed and the processing proceeds to S917 of FIG. 9.

Note that the screen transition diagram generation unit 230 generates a screen transition diagram that is information visually indicating a relationship between transition source screen information and transition destination screen information, by utilizing the screen transition table 254 generated in this manner. The screen transition diagram generation unit 230 generates a screen transition diagram in response to a request via a user interface, for example.

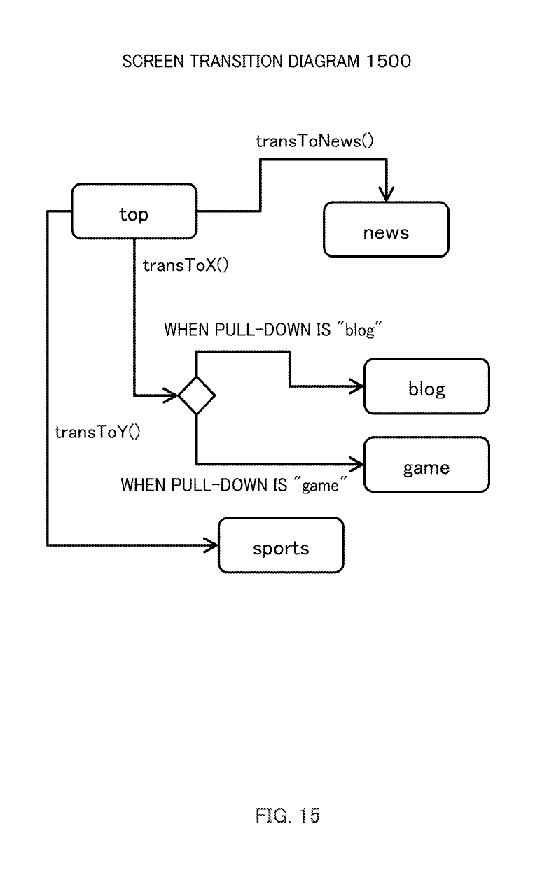

FIG. 15 shows an example of the screen transition diagram. With reference to the screen transition diagram 1500 shown in FIG. 15, a user can easily understand that, for example, the screen ID transitions from the screen of “top” to the screen of “news” via the “transToNews” handler, and the screen ID transitions from the screen of “top” to the screen of “blog” or “game” via the “transToX” handler. Furthermore, a user can easily understand that, for example, the screen ID transitions to the “blog” screen when a transition condition that “pull-down is “blog”” is satisfied, whereas when a transition condition that “pull-down is “game”” is satisfied, the screen ID transitions to the “game” screen. Moreover, according to the screen transition diagram 1500, a user can easily understand that, for example, the transition of the screen ID from the screen of “top” to the screen of “sports” is performed via the “transToY” handler. Note that the transition condition in this case is “when a is less than five”, but since only one screen of the transition destination is valid as described above, the transition condition is not described in this example.

As described above, based on the screen defining function table 251, the controller registration function table 252, and the screen transition function table 253, the screen information generation device 100 of the present embodiment automatically acquires screen definition information and screen transition-related information from the source code 270, and generates screen transition information (screen transition table 254) including the information indicative of a relationship between the transition source screen information and the transition destination screen information. Accordingly, for example, even when the information about the transition of a screen is distributed and described at various places in the source code 270, the information about the transition of a screen can be efficiently obtained. Furthermore, for example, when the screen transition table 254 generated by the screen information generation device 100 and the source code 270 are compared, a place where the both deviate from each other can be easily specified, and the documents used in developing and maintaining software can also be efficiently managed.

Moreover, when the information defining the screen serving as the transition destination of a transition handler is not included in the screen transition table 254 and/or when a transition handler is not actually in use, the filtering unit 213 excludes the information about the relevant transition handler from the screen transition information, and thus a user can efficiently acquire valid information. Furthermore, since the filtering unit 213 automatically determines whether a transition handler is for performing static transition or for performing dynamic transition, and removes the unnecessary information, it is possible to appropriately and efficiently generate screen transition information. Moreover, since the screen transition information complementing unit 214 automatically complements necessary information or otherwise requests a user to perform complement, the necessary information can be efficiently complemented to the screen transition information.

Hereinabove, the present invention has been specifically described based on the embodiments. However, it is needless to say that the present invention is not limited to the above described embodiments and various modifications are possible within the scope not departing from the gist of the invention. For example, the above embodiments have been described in detail in order to clearly explain the present invention, and the present invention is not necessarily limited to the embodiment including all the components described. Furthermore, a part of the components of the above embodiment may be added with other components, be deleted, or be replaced with other components.

Moreover, a part or all of the respective components, functional units, processing units, processing means, and the like may be implemented in hardware by design with an integrated circuit or the like. In addition, the above-described respective configurations, functions, and the like may be implemented in software through interpretation and execution of programs realizing the respective functions, by a processor. The information such as a program, a table, or a file, for realizing each function can be placed on a storage device such as a memory, a hard disk, or an SSD (Solid State Drive), or on a recording medium such as an IC card, an SD card, or a DVD.

Furthermore, in each of the above figures, the lines representing controlling scheme or information transmission considered to be required for the purpose of description are shown, but all the representing lines required for implementation are not necessarily shown. For example, actually almost all components may be considered to be connected to each other.

Moreover, the arrangement forms of the various function units, various processing units, and various databases of the screen information generation device 100 described above are just an example. The arrangement forms of the various function units, various processing units, and various databases can be modified to an optimal arrangement form, from the viewpoints of performances, processing efficiency, communication efficiency, and the like of the hardware and/or software of the screen information generation device 100.

In addition, the configurations (schema etc.) of the above-described database can be flexibly modified from the viewpoints of efficient utilization of resources, increase in processing efficiency, increase in access efficiency, increase in search efficiency, and the like.

What is claimed is:

1. A screen information generation device, comprising:
an information storage unit configured to store a source code, screen defining function information that is information about a screen defining function to define a screen, and screen transition function information that is information about a screen transition function to cause a screen to transition; and
a screen transition information generation unit including: a screen definition information acquisition unit configured to acquire screen definition information that is information about definition of a screen described in the source code, by analyzing the source code based on the screen defining function information; and a screen transition-related information acquisition unit configured to acquire screen transition-related information that is information about transition of a screen described in the source code, by analyzing the source code based on the screen transition function information, the screen transition information generation unit being configured to generate screen transition information including information indicative of a relationship between transition source screen information that is information about a screen of a transition source and transition destination screen information that is information about a screen of a transition destination, based on the screen definition information and the screen transition-related information.

2. The screen information generation device according to claim 1, wherein
the screen definition information acquisition unit specifies, based on a description about a controller included in the source code, a controller class corresponding to the controller, and wherein
the screen transition-related information acquisition unit acquires, based on the controller class, information about a transition handler that performs transition of a screen, as the screen transition-related information.

3. The screen information generation device according to claim 2, further comprising a filtering unit configured to exclude, when information about a screen serving as a transition destination of the transition handler is not included in the transition source screen information, information based on the screen transition-related information about the transition handler from the screen transition information.

4. The screen information generation device according to claim 2, further comprising a filtering unit configured to analyze the source code to determine whether or not the transition handler is actually in use, and exclude, when the transition handler is not actually in use, information based on the screen transition-related information about the transition handler from the screen transition information.

5. The screen information generation device according to claim 4,
wherein the screen transition-related information acquisition unit analyzes the source code to thereby determine whether or not the transition handler is a handler that performs static screen transition, and
wherein when the transition handler defined in the source code is for performing static screen transition, the filtering unit determines whether or not the transition handler is actually in use for each screen serving as a transition destination of the transition handler.

6. The screen information generation device according to claim 5, wherein
when an identifier of a screen of a transition destination is specified as an immediate value in an argument of the screen transition function, the screen transition-related information acquisition unit determines that the transition handler is a handler that performs static transition.

7. The screen information generation device according to claim 5, wherein
when a transition handler which has wrapped the screen transition function and an argument of the screen transition function use a same variable and when an identifier of a screen of a transition destination is specified with an immediate value to call the transition handler, the screen transition-related information acquisition unit determines that the transition handler is a handler that performs static screen transition.

8. The screen information generation device according to claim 4, wherein
the filtering unit makes the determination whether or not the transition handler is actually in use, based on whether or not the transition handler is specified as an attribute value of a predetermined tag described in a screen descriptive sentence of the source code.

9. The screen information generation device according to claim 4, wherein
when the transition handler is used at a plurality of places of one or more screen descriptive sentences about an identical screen, the filtering unit regards an identical transition handler used in transition to a screen of an identical transition destination as the same and does not output duplicated screen transition information.

10. The screen information generation device according to claim 2,
wherein the screen transition-related information acquisition unit analyzes the source code to thereby determine whether or not the transition handler is a handler that performs static screen transition, and
wherein the screen transition-related information acquisition unit includes a screen transition information complementing unit configured to complement the screen transition information when a transition handler defined in the source code is not for performing static screen transition.

11. The screen information generation device according to claim 2,
wherein the screen transition-related information acquisition unit analyzes the source code to thereby determine whether or not the transition handler is a handler that performs static screen transition, and
wherein the screen transition-related information acquisition unit includes a screen transition information complementing unit configured to complement the screen transition information when a transition handler defined in the source code is for performing static screen transition and has a plurality of transition destination screens.

12. The screen information generation device according to claim 1, wherein
the device generates, based on the screen transition information, a screen transition diagram that is information visually indicating information indicative of a relationship between the transition source screen information and the transition destination screen information.

13. A screen information generation method executed by an information processing device including a processor and memory, the method comprising:
storing a source code, screen defining function information that is information about a screen defining function to define a screen, and screen transition function information that is information about a screen transition function to cause a screen to transition;
acquiring screen definition information that is information about definition of a screen described in the source code, by analyzing the source code based on the screen defining function information;
acquiring screen transition-related information that is information about transition of a screen described in the source code, by analyzing the source code based on the screen transition function information; and
generating screen transition information including information indicative of a relationship between transition source screen information that is information about a screen of a transition source and transition destination screen information that is information about a screen of a transition destination, based on the screen definition information and the screen transition-related information.
